(19) United States
(12) Patent Application Publication
(10) Pub. No.: US 2026/0179264 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventor: Satoshi MIYAKE, Toyota-shi (JP)

(73) Assignee: TOYOTA JIDOSHA KABUSHIKI KAISHA, Toyota-shi (JP)

(21) Appl. No.: 19/401,969

(22) Filed: Nov. 26, 2025

(30) Foreign Application Priority Data
Dec. 23, 2024 (JP) 2024-226667

(51) Int. Cl. G06T 11/00

(52) U.S. Cl. CPC G06T 11/00

(57) ABSTRACT

An information processing device includes: an acquisition unit configured to acquire, as instruction data, a graph structure entered by a user; a generation unit configured to generate an image based on the instruction data; a conversion unit configured to convert the generated image into a graph structure; a calculation unit configured to calculate the difference between the graph structure of the instruction data and the graph structure converted from the generated image; a regeneration instruction unit configured to, when the difference is greater than or equal to a predetermined value, instruct the generation unit to regenerate the image such that the difference is reduced; and an output unit configured to, when the difference is less than the predetermined value, output the generated image to the user.

### CROSS-REFERENCE TO RELATED APPLICATION

This application claims priority to Japanese Patent Application No. 2024-226667 filed on Dec. 23, 2024. The disclosure of the above-identified application, including the specification, drawings, and claims, is incorporated by reference herein in its entirety.

### BACKGROUND

### 1. Technical Field

This disclosure relates to the technical field of information processing devices.

### 2. Description of Related Art

As an example of this type of device, a system has been proposed in which a large language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

When an image is generated using a trained model, an image that does not match the user's intention (for example, an image that slightly deviates from the user's instruction) may be generated. In such cases, the user needs to provide additional instructions to correct the image, leading to repeated interactions between the user and the device. This results in technical issues such as increased user effort and reduced convenience.

The present disclosure has been made in view of the above issues, and an object thereof is to provide an information processing device capable of appropriately generating an image intended by a user.

An information processing device according to one aspect of the present disclosure includes: an acquisition unit configured to acquire, as instruction data, a graph structure entered by a user; a generation unit configured to generate an image based on the instruction data; a conversion unit configured to convert the generated image into a graph structure; a calculation unit configured to calculate the difference between the graph structure of the instruction data and the graph structure converted from the generated image; a regeneration instruction unit configured to, when the difference is greater than or equal to a predetermined value, instruct the generation unit to regenerate the image such that the difference is reduced; and an output unit configured to, when the difference is less than the predetermined value, output the generated image to the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of an information processing device according to an embodiment;

FIG. 2 is a block diagram illustrating a functional configuration of the information processing device according to the embodiment; and

FIG. 3 is a flowchart illustrating the operation of the information processing device according to the embodiment.

### DETAILED DESCRIPTION OF EMBODIMENTS

An embodiment of an information processing device will be described below with reference to the drawings.

### Hardware Configuration

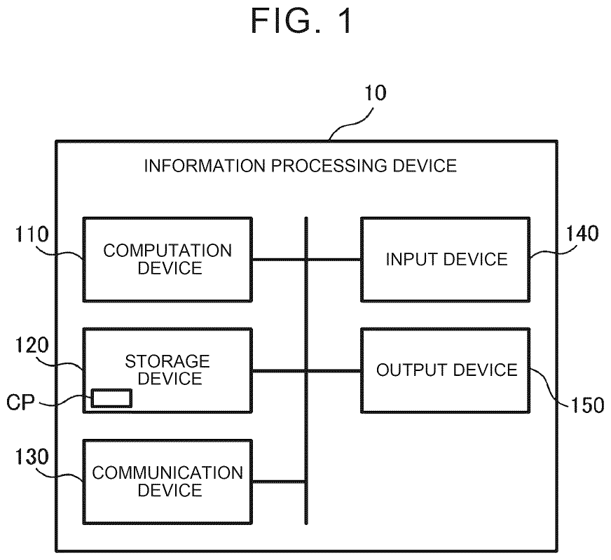

First, a hardware configuration of the information processing device according to the embodiment will be described with reference to FIG. 1. FIG. 1 is a block diagram illustrating the hardware configuration of the information processing device according to the embodiment.

In FIG. 1, an information processing device 10 according to the embodiment includes a computation device 110, a storage device 120, a communication device 130, an input device 140, and an output device 150. The computation device 110, the storage device 120, the communication device 130, the input device 140, and the output device 150 are connected to each other via a data bus.

The computation device 110 is configured to execute various computational processes in the information processing device 10. The computation device 110 may include a processor. The computation device 110 may include a single processor or may include a plurality of processors. In other words, the computation device 110 may include one or more processors. The processor may be a multicore processor. When the computation device 110 includes a single processor that is a multicore processor, the computation device 110 can logically be regarded as including a plurality of processors.

The processor included in the computation device 110 may be, for example, at least one of the following: a central processing unit (CPU), a graphics processing unit (GPU), a field programmable gate array (FPGA), and a tensor processing unit (TPU).

The storage device 120 may be, for example, at least one of the following: a random access memory (RAM), a read-only memory (ROM), a hard disk drive, a magneto-optical disk drive, a solid-state drive (SSD), and an optical disk array. That is, the storage device 120 may be implemented using a single device or may be implemented using a plurality of devices.

The storage device 120 is capable of storing desired data. The storage device 120 may store a computer program CP that is executed by the computation device 110. When the computation device 110 is executing the computer program CP, the storage device 120 may temporarily store data temporarily used by the computation device 110.

The computer program CP may be recorded on a computer-readable and non-transitory recording medium. In this case, the computer program CP may be stored in the storage device 120 by reading the recording medium using a recording medium reader (not shown) included in the information processing device 10. At least one of the following media may be used as the recording medium: an optical disk, a magnetic medium, a magneto-optical disk, a semiconductor memory, and any other medium capable of storing programs. The computer program CP may be acquired from a device (not shown) external to the information processing device 10 via the communication device 130. In other words, the computer program CP may be downloaded from an external device to the storage device 120 of the information processing device 10.

The computation device 110 (e.g., a processor), together with the storage device 120 storing the computer program CP (in other words, together with the storage device 120 and the computer program CP stored in the storage device 120), may execute processing to be performed by the information processing device 10. For example, logical functional blocks for executing the processing to be performed by the information processing device 10 may be implemented within the computation device 110 (e.g., within the processor) by the computation device 110 executing the computer program CP.

The communication device 130 is configured to communicate with a device external to the information processing device 10. The communication device 130 may perform wired communication or wireless communication.

The input device 140 is a device capable of receiving information input from outside to the information processing device 10. The input device 140 may include an operation device operable by a user of the information processing device 10 (e.g., a keyboard, a mouse, a touch panel, etc.). The input device 140 may include a recording medium reader capable of reading information recorded on a recording medium (such as a Universal Serial Bus (USB) memory) that is attachable to and detachable from the information processing device 10. When information is input to the information processing device 10 via the communication device 130 (in other words, when the information processing device 10 acquires information via the communication device 130), the communication device 130 may serve as an input device.

The output device 150 is a device capable of outputting information to the outside of the information processing device 10. The output device 150 may include a display device capable of outputting visual information such as text or images as the output information. The output device 150 may include a speaker capable of outputting auditory information such as sound as the output information. The output device 150 may be configured to output the above information (e.g., control information for other devices) to other devices. The output device 150 may be capable of outputting information to a recording medium that is attachable to and detachable from the information processing device 10, such as a USB memory. When the information processing device 10 outputs information via the communication device 130, the communication device 130 may serve as an output device.

### Functional Configuration

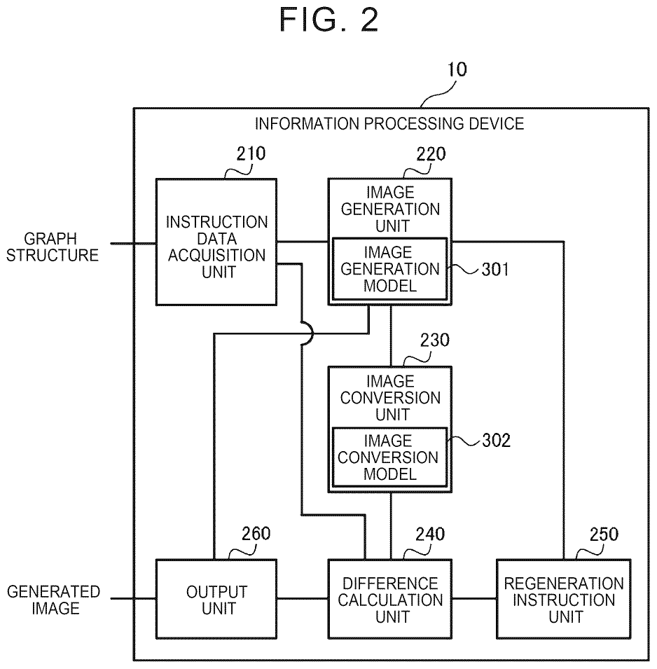

Next, a functional configuration of the information processing device 10 according to the embodiment will be described with reference to FIG. 2. FIG. 2 is a block diagram illustrating the functional configuration of the information processing device according to the embodiment.

In FIG. 2, the information processing device 10 is configured as a device that generates an image based on instruction data entered by the user. The information processing device 10 includes, as components for implementing its functions, an instruction data acquisition unit 210, an image generation unit 220, an image conversion unit 230, a difference calculation unit 240, a regeneration instruction unit 250, and an output unit 260. Each of the instruction data acquisition unit 210, the image generation unit 220, the image conversion unit 230, the difference calculation unit 240, the regeneration instruction unit 250, and the output unit 260 may be a processing block implemented by the computation device 110 described above.

The instruction data acquisition unit 210 is configured to acquire instruction data entered by the user. The instruction data is acquired as a graph structure. The graph structure may refer to data constituted by a group of nodes representing parts of an object in an image corresponding to one piece of image data and a group of edges indicating relationships among the nodes. The instruction data acquisition unit 210 may have a function to convert the acquired graph structure into a feature vector.

The image generation unit 220 is configured to generate an image from the graph structure acquired by the instruction data acquisition unit 210. That is, the image generation unit 220 converts a graph structure expressed by the user into an image. The image generation unit 220 may generate the image using a pre-trained image generation model 301. The image generation model 301 may be a model that takes a graph structure (or a feature vector of the graph structure) as input and outputs an image.

The image conversion unit 230 is configured to convert the image generated by the image generation unit 220 (hereinafter referred to as “generated image” as appropriate) into a graph structure. That is, the image conversion unit 230 converts the image converted from the graph structure by the image generation unit 220 back into a graph structure. The image conversion unit 230 may convert the image into a graph structure using a pre-trained image conversion model 302. The image conversion model 302 may be a model that takes an image as input and outputs a graph structure (or a feature vector of the graph structure).

The difference calculation unit 240 is configured to calculate the difference between the graph structure acquired by the instruction data acquisition unit 210 and the graph structure converted by the image conversion unit 230. That is, the difference calculation unit 240 calculates the difference between the graph structure entered by the user as instruction data and the graph structure converted from the image generated based on the instruction data. The difference calculation unit 240 may calculate the difference between feature vectors of the graph structures.

The regeneration instruction unit 250 is configured to output an instruction to regenerate the image to the image generation unit 220. Specifically, when the difference calculated by the difference calculation unit 240 is greater than or equal to a predetermined value, the regeneration instruction unit 250 outputs an instruction to regenerate the image to the image generation unit 220. The “predetermined value” herein is a threshold for determining whether the difference between the graph structure entered by the user and the graph structure converted from the generated image is large enough to determine that the image should be regenerated. When instructing regeneration, the regeneration instruction unit 250 outputs an instruction to regenerate the image such that the difference calculated by the difference calculation unit 240 is reduced.

The output unit 260 is configured to output the image generated by the image generation unit 220 to the user. Specifically, when the difference calculated by the difference calculation unit 240 is less than the predetermined value, the output unit 260 outputs the generated image to the user. The output unit 260 may, for example, output the generated image by displaying it on a display.

### Operation Flow

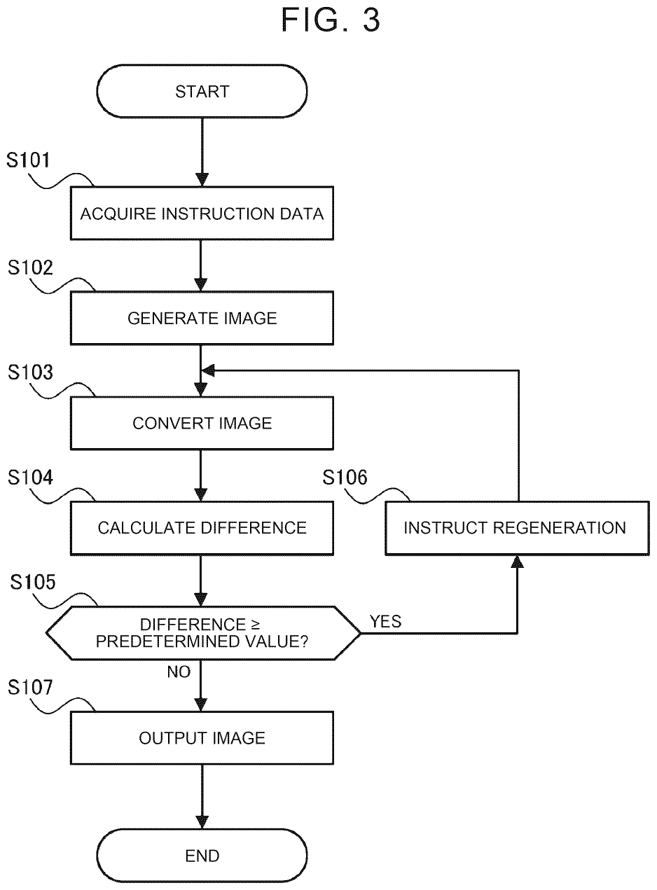

Next, the operation flow of the information processing device 10 according to the embodiment will be described with reference to FIG. 3. FIG. 3 is a flowchart illustrating the operation flow of the information processing device according to the embodiment.

As shown in FIG. 3, when the operation of the information processing device 10 according to the embodiment is started, the instruction data acquisition unit 210 first acquires a graph structure entered by the user as instruction data (step S101). The image generation unit 220 then generates an image from the graph structure acquired by the instruction data acquisition unit 210 (step S102).

Thereafter, the image conversion unit 230 converts the image generated by the image generation unit 220 into a graph structure (step S103). The difference calculation unit 240 then calculates the difference between the graph structure acquired by the instruction data acquisition unit 210 and the graph structure converted by the image conversion unit 230 (step S104).

When the difference calculated by the difference calculation unit 240 is greater than or equal to the predetermined value (step S105: YES), the regeneration instruction unit 250 instructs the image generation unit 220 to regenerate the image (step S106). In this case, the processing of step S103 is executed again using the regenerated image. Regeneration of the image is thus repeated until the difference becomes less than the predetermined value.

On the other hand, when the difference calculated by the difference calculation unit 240 is less than the predetermined value (step S105: NO), the output unit 260 outputs the image generated by the image generation unit 220 (step S107). When the image has been regenerated, the output unit 260 outputs the regenerated image (specifically, the image obtained when the difference has become less than the predetermined value).

### Technical Effects

Next, technical effects obtained by the information processing device 10 according to the embodiment will be described.

As described with reference to FIGS. 1 to 3, in the information processing device 10 according to the embodiment, an image is generated from a graph structure input as instruction data. When the difference between the graph structure that is the instruction data and the graph structure converted from the generated image is greater than or equal to the predetermined value, the image is regenerated. It is thus possible to output an image that matches the user's intention (that is, an image accurately converted from the graph structure that is the instruction data). Specifically, even when the image generation unit 220 fails to convert the graph structure into an appropriate image in a single attempt, the image is regenerated such that the difference between the graph structure of the instruction data and the graph structure of the generated image is reduced, thereby bringing the image closer to the one intended by the user.

It is conceivable to re-enter new instruction data when an appropriate image is not generated. However, this would require the user to enter a new graph structure. Moreover, entering a new graph structure does not necessarily result in an appropriate image. This leads to repeated interactions between the user and the device. However, with the information processing device 10 according to the present embodiment, image regeneration is automatically performed based on the difference between graph structures. Therefore, it is possible to generate an image that matches the user's intention without increasing the user's effort.

Aspects of the disclosure derived from the above embodiment will be described below.

An information processing device according to one aspect of the present disclosure includes: an acquisition unit configured to acquire, as instruction data, a graph structure entered by a user; a generation unit configured to generate an image based on the instruction data; a conversion unit configured to convert the generated image into a graph structure; a calculation unit configured to calculate the difference between the graph structure of the instruction data and the graph structure converted from the generated image; a regeneration instruction unit configured to, when the difference is greater than or equal to a predetermined value, instruct the generation unit to regenerate the image such that the difference is reduced; and an output unit configured to, when the difference is less than the predetermined value, output the generated image to the user. In the above embodiment, the “instruction data acquisition unit 210” is an example of the “acquisition unit,” the “image generation unit 220” is an example of the “generation unit,” the “image conversion unit 230” is an example of the “conversion unit,” the “difference calculation unit 240” is an example of the “calculation unit,” the “regeneration instruction unit 250” is an example of the “regeneration instruction unit,” and the “output unit 260” is an example of the “output unit.”

In the information processing device according to the above aspect, the generation unit may include a first machine learning model configured to take, as input, the graph structure that is the instruction data and outputs the image, and the conversion unit may include a second machine learning model configured to take the generated image as input and outputs the graph structure. In this configuration, since the model used to generate an image from a graph structure and the model used to convert an image into a graph structure are different from each other, it is possible to more accurately instruct regeneration of the image.

The present disclosure is not limited to the embodiment described above, and various modifications can be made as appropriate without departing from the gist or spirit of the disclosure as understood from the claims and the entire specification. Information processing devices incorporating such modifications are also within the technical scope of the present disclosure.

What is claimed is:

1. An information processing device comprising:
an acquisition unit configured to acquire, as instruction data, a graph structure entered by a user;
a generation unit configured to generate an image based on the instruction data;
a conversion unit configured to convert the generated image into a graph structure;
a calculation unit configured to calculate a difference between the graph structure of the instruction data and the graph structure converted from the generated image;
a regeneration instruction unit configured to, when the difference is greater than or equal to a predetermined value, instruct the generation unit to regenerate the image such that the difference is reduced; and
an output unit configured to, when the difference is less than the predetermined value, output the generated image to the user.

2. The information processing device according to claim 1, wherein:
the generation unit includes a first machine learning model configured to take, as input, the graph structure that is the instruction data and outputs the image; and
the conversion unit includes a second machine learning model configured to take the generated image as input and outputs the graph structure.
